(19) United States
(12) Patent Application Publication
(10) Pub. No.: US 2014/0338655 A1
(43) Pub. Date: Nov. 20, 2014

(54) UNIVERSAL PORTABLE KITCHEN

(71) Applicant: Mark DOYLE, Montreal (CA)

(72) Inventor: Mark DOYLE, Montreal (CA)

(21) Appl. No.: 13/897,557

(22) Filed: May 20, 2013

(51) Int. Cl. B60P 3/025; B60R 15/02; A47K 1/02

(52) U.S. Cl. CPC B60P 3/0257; A47K 1/02; B60R 15/02
USPC 126/276; 4/630; 126/268

(57) ABSTRACT

A universal portable kitchen package is provided for use with aid relief in a disaster zone. A self-sufficient kitchen package includes: a portable kitchen unit that has a sink attached to a drainage hose, a storage space and a workspace; an external firebox; an external water filtration system; a survival kit; a set of basic kitchen utensils and other additional elements which would be needed for survival of a family of 4-6 persons in a distress zone or inside small housing/infrastructure. The portable kitchen unit comprises three compartments: a utility compartment under the sink area, a food compartment and a supply compartment under the countertop workspace. The portable kitchen unit is disposed on detachable wheels. Undercarriage height provides maximum clearance when the portable kitchen unit is transported on the ground. A push-bar can be provided to aid in the pushing of the kitchen unit, and the bar can also act as a towel rack.

### FIELD OF THE INVENTION

The present invention relates to a portable kitchen package that can be used anywhere, and more particularly, in the areas where aid relief is deployed. The portable kitchen package contains a portable cart provided with a sink, a top workspace and three storage compartments; a firebox, a water filtration system, and basic supplies to sustain a family of 4 to 6 for an indefinite term.

### BACKGROUND OF THE INVENTION

When humanitarian crises occur due to armed conflicts, natural disasters, epidemics, etc. the international community responds with humanitarian aid that provides material and logistical assistance to save lives, alleviate suffering and maintain a certain level of living comfort for large groups of affected population. Sick, wounded or displaced people need food, water, medical supplies, etc. The delivery of humanitarian aid can become a logistical challenge for aid workers when there are thousands of people to care for. In a crisis situation, it is instrumental to provide the basics for human survival, with a priority for food and food preparation. Lack of conditions required for food preparation at the family level puts a greater demand on aid workers. The aid relief activity would greatly benefit in this regard if there were portable kitchens that could be easily transported and deployed to families in need and would come with a set of essential items for food preparation.

In the past, attempts have been made to provide portable kitchens mostly directed to food preparation during outdoor activities or at remote sites where conventional kitchens are not available. Certain attempts included kitchen utilities such as sinks with drainage, burners for cooking, utensils for preparing and serving the food, containers or enclosures for storing various camping supplies such as stoves, utensils for cooking, and the like.

One example of a portable kitchen, toilet and shower unit is disclosed in U.S. Pat. No. 5,862,540 where the unit comprises a sink, a work top, cupboards, a gas-operated cooking device, water container, a portable chemical toilet, a shower set, an electrical pump for pumping water to the sink and shower head. The unit is sized as to fit into the back of a vehicle having rear door or doors for transport and can be used when the unit is positioned in the back of the car. The kitchen disclosed in U.S. Pat. No. 5,862,540 is not portable without the aid of a motor vehicle.

Another example of a camper style kitchen is disclosed in U.S. Pat. No. 6,883,881 which relates to a portable kitchen comprising an adjustable kitchen surface, two sinks provided with faucets and drainage, folding legs with adjustable length, rack shelves for storage and for supporting at least one heat cooking device and a storage cavity for folding legs, shelves and other accessories. The design requires set-up, with foldable parts reducing overall stability of the unit during use. Although the kitchen has a sink, the sink depth is drastically less than typical, causing difficulty while washing larger items. The storage areas are open to the elements and non-existent during transportation.

U.S. Pat. No. 5,683,157 relates to a portable kitchen for storing and preparing food, comprising a main box provided with storing compartments, a table and a sink designed as the lid for the box. The compartments could be used to store camping items. The sink is attached to the main box through hinges and can be detached from the main box. The box is made of light-weight plastic and it is provided with handles for comfortably carrying it. The sink of the invention does not have drainage making it difficult to use. The kitchen comes as a box that requires lifting during manual transportation. Also, the unit requires a support to achieve effective workspace height.

U.S. Pat. No. 6,543,436 relates to a portable kitchen that comes as a base unit in the form of a box with handles and it provides an internal cooking surface, work surface, compartments for utensils, shelves hinged to the base unit. It could come with removable legs or permanently attached folding legs. Multi-purpose racks can be extended from both ends of the base unit. The design does not include a sink and the camp box is not attached to the stand, but rather it is supported by a stand.

U.S. Pat. No. 5,970,855 relates to a portable kitchen which provides a cooking surface that can be moved from the position situated over the heat source to a lateral position. The base unit includes storage units and may include a refrigerated compartment. The unit is mounted on at least two wheels for portability. The unit does not include a sink and the heat source for cooking is liquid fuel like propane.

While these various prior art portable kitchens have worked with some degree of success for outdoor food preparation, various shortcomings make them inadequate for use in disaster relief response efforts. For example, one perceived difficulty with prior art portable kitchens is the need to be transported by hand, which can be awkward and strenuous to the human body. Another shortcoming of the prior art portable kitchens relates to the need to assemble and set-up the kitchen. Yet another shortcoming of prior art portable kitchens relates to a reduced stability and reduced cooking space of the kitchen unit during use. Additionally, the stoves disclosed in prior art require liquid fuel, which is difficult to supply in disaster scenarios. A portable kitchen intended for displaced families should include all needed equipment and supplies for food storage and preparation so as to be a self-sufficient package aid.

In summary, none of the known portable kitchens offer the unique and innovative combination of structural and functional characteristics of the invention disclosed herein.

### SUMMARY OF THE INVENTION

The following summary is intended to highlight and introduce some aspects of the various exemplary embodiments, but not to limit the scope of the invention. Detailed descriptions of a preferred exemplary embodiment allowing those skilled in the art to make and use the inventive concepts are provided by the entire disclosure.

It is an object of the present invention to provide a universal portable kitchen package.

Accordingly, in one non-limiting embodiment of the present invention, there is provided a universal portable kitchen package comprising a portable kitchen unit, an external portable firebox, a water filtration system, a basic utensil set, wherein the portable kitchen unit comprises a sink, a countertop workspace and storage compartments.

According to another embodiment of the present invention, the underside of the portable kitchen unit has provisions for attaching wheels to the unit. Preferably, the wheels are detachable for shipping and can be easily attached to the unit and locked in with a snap in and lock connection. The undercarriage height may be 10 inches, but the height range can vary such as to provide for easier manual transportation of the kitchen unit over uneven terrain. The wheels are connected to the structural support of the kitchen unit, comprising cross bars provided at the base of the unit. The axle rods that connect the wheels to the base of the kitchen unit are constructed of strong steel.

According to another embodiment of the present invention, the sink is provided with a drain connected to a drainage hose to facilitate proper drainage.

Preferably, the portable kitchen unit includes a utility storage compartment beneath the sink area, and a food storage compartment and a supply storage compartment positioned beneath the countertop workspace. Preferably, the countertop workspace is large enough to provide ample space for meal preparation and other kitchen related tasks. The countertop may have a small upwardly protruding edge to prevent objects and liquid from rolling or spilling off Each compartment may have an access hatch that can be secured. The utility compartment may be sealed off from the food storage and supply area to prevent any transmission of bacteria from the sink drainage hose should a leak occur. Drainage hose and basic cleaning supplies may be stored in the utility compartment. Preferably, the unit is constructed with hard, durable plastic panels or molded shell. The plastic walls between compartments may act as structural support for added weight of the sink when it is filled with water, and for the workspace.

Preferably, the kitchen unit may have a width of 2 feet and 6 inches (or about 760 mm), a height of 3 feet (about 900 mm) and a length of 6 feet (about 1820 mm), but greater or smaller sizes could be employed if desired.

According to another embodiment of the invention, the kitchen unit corners are rounded to prevent injury from sharp edges. According to still another embodiment of the present invention, the kitchen unit may be provided with at least one push-bar on at least one side to aid in the movement of the unit and to also act as a towel rack.

According to still another preferred embodiment of the invention, the portable kitchen package is provided with an external cooking firebox made of stainless steel. The firebox may be a closed square box provided on one side with an opening for different fuel types, like wood. The top surface will preferably have ½ inch holes spaced equally throughout to provide venting to the cooking surface.

According to still another embodiment of the invention, the portable kitchen package may include a mold to compress fuel sources like wet sawdust and/or recycled paper into fire bricks. The bricks may substitute for wood in the firebox.

To aid with cooking, the portable kitchen package may include a basic utensil and bowl set, along with at least a pot and ladle, and cleaning supplies. The package may include bottles for water storage and an initial non-perishable food source like a bag of rice or any dried food suitable for preservation without a refrigerator. A survival kit comprising a basic first-aid kit, a blanket, hand sanitizer, candles, a tarp and rope may also be included in the kitchen package to act as a rain cover.

As an aspect of the present invention, there is provided a portable kitchen unit comprising: a substantially horizontal planar working area disposed on an upper area of the unit, structured and dimensioned to satisfy the operational criteria of the unit; a sink assembly structured and adapted for utilitarian co-operation with the planar working area; and at least one storage compartment positioned beneath the planar working area.

As another aspect of the present invention, there is provided an external cooking firebox comprising: an enclosed box defining a top side, a bottom side and four lateral sides made of a fire-resistant material having an opening adjacent the top side leaving a lip adjacent the bottom side on one of the lateral sides and the top side having a plurality of holes incorporated therein.

As another aspect of the present invention, there is provided a portable kitchen kit for disaster relief comprising: a portable kitchen unit as defined in the present invention; and an external cooking firebox as defined in the present invention.

### BRIEF DESCRIPTION OF THE DRAWINGS

FIG. 1 is a top view of the portable kitchen unit;

FIG. 2 shows a cross-section view in a vertical plan of the portable kitchen unit of FIG. 1, taken along section A-A;

FIG. 3 shows a longitudinal cross-section in a horizontal plan of the portable kitchen unit, taken along section B-B shown in FIG. 2;

FIG. 4 shows the longitudinal cross-section in a vertical plan of the portable kitchen unit similar to the view shown in FIG. 2, additionally having the kitchen unit provided with attached wheels;

FIG. 5 shows a detailed view of the connection of the wheels to the portable kitchen unit shown in FIG. 4;

FIG. 6 is a lateral view of the portable kitchen unit with attached wheels;

FIG. 7 is a lateral view of the portable kitchen unit with attached wheels, showing the utility compartment side;

FIG. 8 is a perspective view of the firebox;

FIG. 9 shows a perspective view of a support for onboard fire box provided with insulation layer;

FIG. 10 shows a front view of an embodiment of a firebrick molder;

FIG. 11 shows a lateral view of the firebrick molder shown in FIG. 10;

FIG. 12 is a diagram showing the preparation of the mix for firebricks;

FIG. 13 shows a second embodiment of the portable kitchen unit;

FIG. 14 shows the portable kitchen unit with a strapped cargo;

FIG. 15a shows a perspective view of a hook for tying the cargo to the kitchen unit;

FIG. 15b shows a cross-sectional view of the hook shown in FIG. 15a, taken along line C-C;

FIG. 16 shows a cross-section view of another embodiment of the hook;

FIG. 17 shows a perspective view of the portable kitchen unit;

FIG. 18 shows a perspective view of a vertical and longitudinal cross-sectional view of the kitchen unit; and

FIG. 19 shows a tridimensional sectional view of the portable kitchen unit, taken along section A-A of FIG. 1.

FIG. 20 shows a lateral view of the portable kitchen unit according to another embodiment of present invention.

### DETAILED DESCRIPTION OF THE INVENTION

The following description is presented to enable a person skilled in the art or science to which the present invention pertains to make and use the invention, and is provided in the context of a particular application and its requirements.

In the following description, Uni-kit designates the universal portable kitchen package, which may comprise a portable kitchen unit, a water filtration system, an external firebox, fire sources and basic supplies. Uni-kit can be used in various scenarios and it is preferably used as an aid relief, not only as a utility cart, to sustain a family of 4 to 6 for an indefinite term in a disaster area, and, also, in a small housing system, the portable kitchen unit comprising a sink, a workspace and three areas for storage, all contained in a plastic shell on independently turning wheels. The purpose of the Uni-kit is to provide easy to use infrastructure when needed, to be a self-sufficient aid kitchen package to displaced families or in new developments, eventually in remote areas of the world. Being a self-sufficient portable package, Uni-kit reduces the work load of aid relief workers.

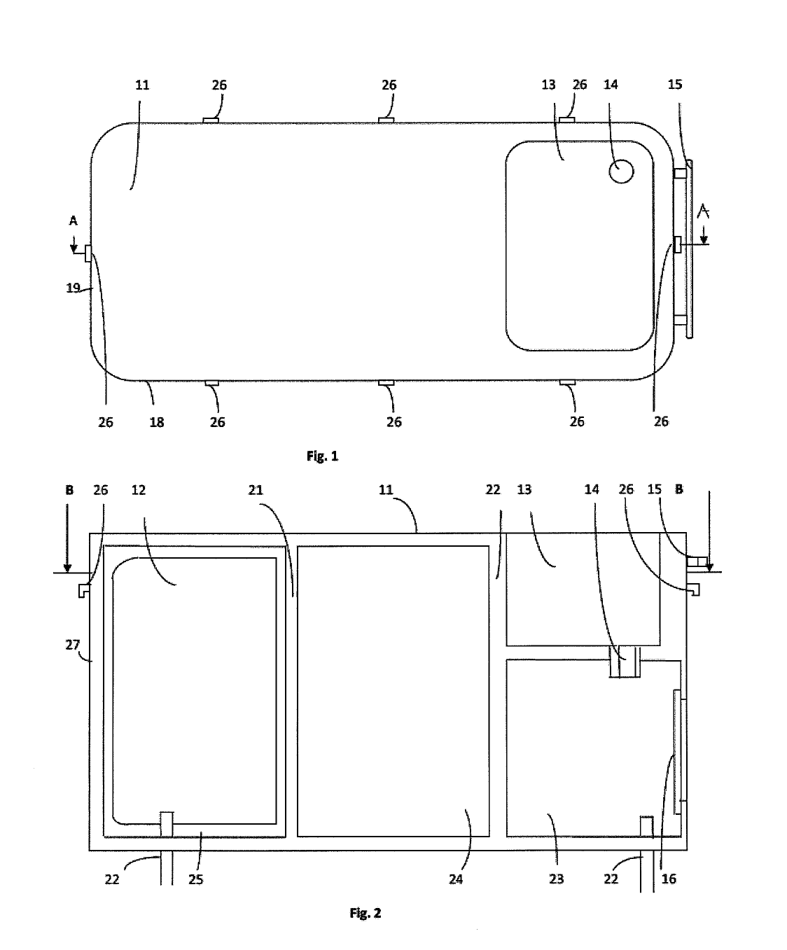

Referring to FIG. 1, there is shown a top view of an example embodiment of the portable kitchen unit. FIG. 2 shows a cross-sectional view of the portable kitchen unit of FIG. 1 taken along section A-A shown in FIG. 1. The outer shell of the portable kitchen unit can be made of traditional hard durable plastic or bio-plastic which can rapidly biodegrade. Preferably, the kitchen units that are intended for short uses will be made of bio-plastic. When the units are discarded, they will biodegrade easily. The hard, durable shell can be made of any other suitable material. The top of the unit is of rectangular shape having a counter workspace 11 provided with upwardly protruding edges not shown in the drawings and a sink workspace accommodating a sink 13 positioned at one end of the workspace. The counter workspace portion 11 of the top of the unit is large enough to provide ample space for meal preparation or other tasks related to cooking and meal serving. To provide a comfortable cooking setting, the counter preferably has a height 27 of at least 36 inches. The body of the portable kitchen unit is preferably divided into three compartments that can be used as a utility compartment 23, a food storage compartment 24 and a supply compartment 25. It should be understood that the body can be divided in any other number of compartments for various uses.

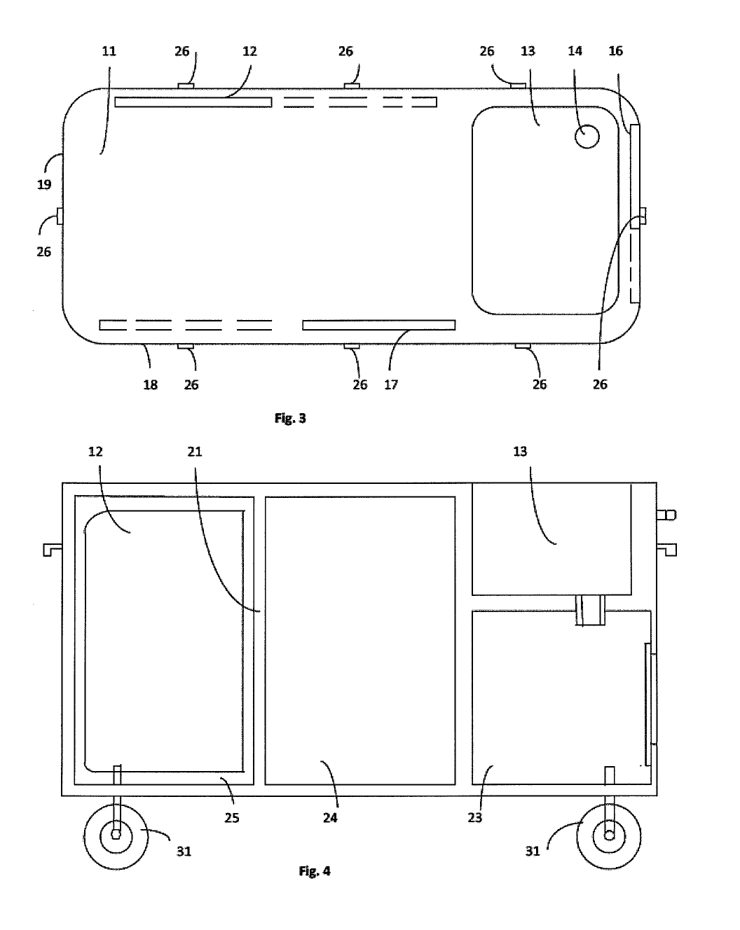

In FIG. 3, which shows a longitudinal cross-section in a horizontal plan of the portable kitchen unit, taken along section B-B shown in FIG. 2, it can be seen that each compartment has its own access door (16, 17, 12) that can be secured. Preferably, the utility compartment 23 is provided under the sink 13 whose drain 14 is aligned over the utility door 16. It should be understood that the utility door 16 can be provided on any external vertical wall of the utility compartment. The food storage and supplies compartment doors (12, 17) are shown on opposite sides of the kitchen unit in the example embodiment of the present invention, but it should be understood that they can be provided in any other configuration on the external vertical walls of the food storage and supplies compartments of the portable kitchen unit. In the example embodiment, the compartment doors are shown as sliding doors. Other designs could also be used to attach and actuate the doors. For optimum access to the food storage and supplies compartment, the access doors 12, 17 preferably have a width greater than 20 inches. Each door will have a locking mechanism to ensure the doors do not open during transportation. The length 18 of the kitchen unit is preferably 6 feet to maximize storage and workspace area. The width 19 of the portable kitchen unit is preferably 30 inches to ensure that the kitchen unit can pass through any doorway. International building code states that the main door to a family dwelling shall be no less than 3 feet (36 inches) in width. The wall 22 between the utility compartment and the next compartment acts as a structural support for the added weight when the sink is filled with water. The divider 21 between the food storage compartment and supplies compartment also adds support to the workspace.

The sink drain 14 is aligned over the door of compartment. A drainage hose is attached to the sink drain 14 to facilitate the drainage. The length of the hose is chosen such as to accommodate proper water drainage away from the kitchen unit. When not in use, the drainage hose could be stored in the utility compartment along with some basic cleaning supplies. The utility compartment will be sealed off by means of wall 22 from the food storage and supplies compartments to prevent any bacterial contamination from the drainage hose should a leak occur. The size of the sink 13 is preferably 1 foot 3 inches by 2 feet 2 inches, typical to North American style residential kitchen sizes. It should be understood that other sizes may be provided.

Preferably, all the corners of the kitchen unit will be rounded to prevent injury from sharp edges. The kitchen unit could be tan in color, but any other color may be used.

An optional push-bar 15 can be attached, as it can best be seen in FIG. 1, to the end of the kitchen unit proximate to the sink or to any side of the kitchen unit. While the drawings of the present invention show one push-bar attached to the end side close to the sink, the kitchen unit can also be provided with two or more push-bars attached to the sides of the kitchen unit. The purpose of the push-bar is to aid in the kitchen unit movement and it can have an additional use as a towel rack.

The kitchen unit is provided with wheel supports 22 to connect wheels to the kitchen unit.

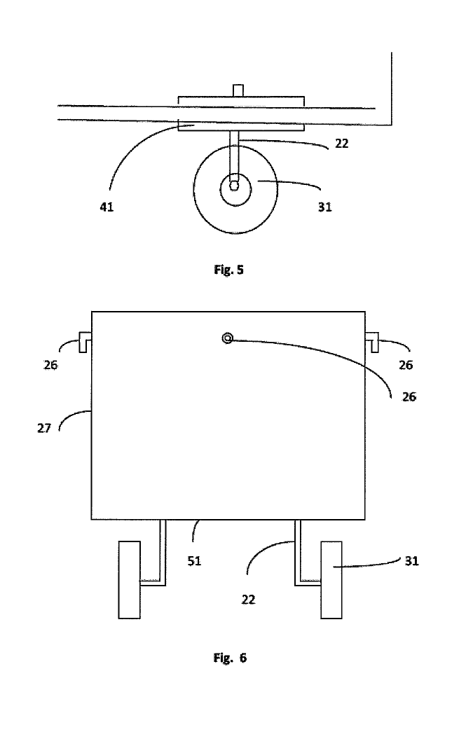

In FIG. 4 there is shown a cross-section view of the portable kitchen unit shown in FIG. 1, taken along section A-A, the kitchen unit having wheels attached to the base of the unit.

The kitchen unit may be provided with wheels 31 attached to the base of the unit by wheel supports 22 preferably constructed of strong steel. The wheel design is important as the kitchen unit is mainly intended for use in a disaster zone where it might be required to be manually moved over rough terrain. The actual tire is made of resilient material, such as rubber, mounted on a strong, hard rim, such as a metal rim. The tires could be air inflated to allow smooth movement over rough terrain. It has been noted that if one pair of wheels is fixedly connected to the bottom of the unit, it is difficult to push or pull the unit on rough terrain. In a preferred embodiment of the present invention, the connection of the wheel supports to the bottom of the cart allows all the wheels to have a 360 degree rotational movement. A sub-optimal design would have one pair of wheels, aligned parallel either the longer or shorter side of the unit, fixedly connected to the bottom of the unit. The attachment of the wheel to the axle rods is provided with snap in and lock connection. Alternatively, the attachment of the axle rods to the bottom of the kitchen unit has a snap in and lock connection. The wheels will be stored inside the kitchen unit until the Uni-kit is delivered. Once delivered, the wheels are attached to the bottom of the unit and locked in. This feature makes the Unit-kit easier to ship.

FIG. 5 shows an enlarged view of the connection of the wheel to the bottom of the kitchen unit. The structural support for the wheels 31 is achieved by a plurality of cross bars 41. Each cross bar extends between two wheels and it is aligned parallel to either the smaller side or the longer side of the kitchen unit. The purpose of the cross bars is to evenly distribute the kitchen unit weight onto the wheels.

For better stability of the portable kitchen unit, weight can be added to the cross bars to lower the gravity center of the unit. In a preferred embodiment, a water storage tank can be provided as an added optional weight to increase the stability of the unit.

FIG. 6 shows a lateral view of the portable kitchen unit shown in FIG. 1, seen with attached wheels. The geometry of the axle rods 22 will allow for 360 degree movement of the wheels. The bottom 51 of the kitchen unit will preferably be at height of about 10 inches to provide maximum clearance over obstacles when the unit is being transported manually. Smaller heights are also considered.

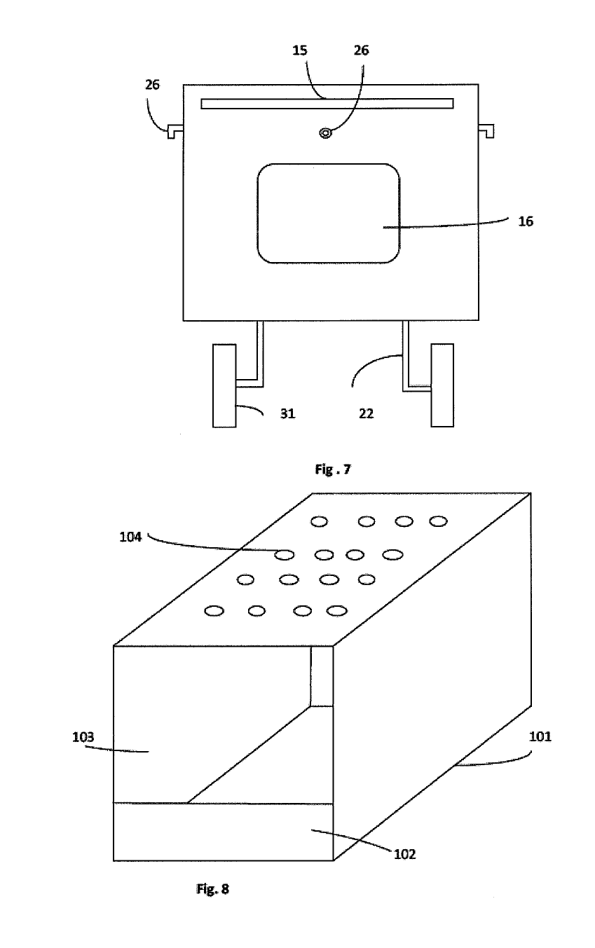

FIG. 7 shows a lateral view of the kitchen unit seen from the utility compartment end and having the access door 16 and the push-bar 15 provided on the small wall adjacent to the utility compartment.

To be self-sufficient, the Uni-kit comprises additional elements needed for survival in a distress area. An important element for survival is having a cooking facility that would make use of readily available fuel source in remote area where conventional

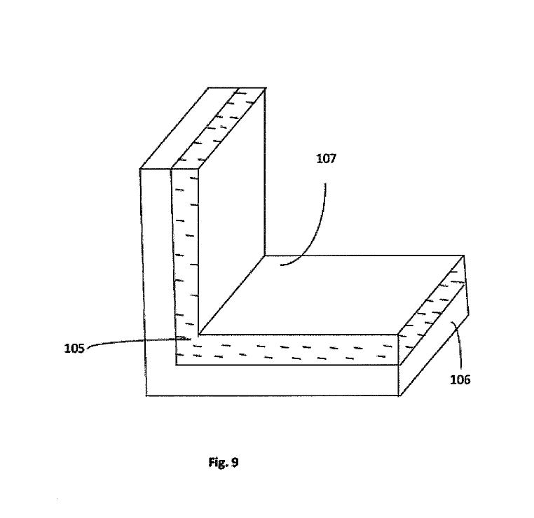

FIG. 8 shows an external portable firebox that is provided with the Uni-kit package to facilitate cooking. The firebox is designed as an enclosure shaped as a box, having walls made of fire-resistant material such as stainless steels, having an opening 103 on one lateral side for feeding the fuel source of different types, like wood, paper, charcoal, etc.

The opening 103 is provided adjacent upper side of the box, leaving a lip 102 on the lateral side adjacent the base of the box to prevent the fuel source from falling out of the box. The upper side of the box has holes 104 equally spaced throughout to provide venting to the cooking surface. The holes can be square holes of ½ inches or of any other shape with an opening area of about one square inch or less. To offer enough cooking space and still be easy to deposit and transport, the firebox may be a square box of 18″×18″×18″. Other dimensions can also be provided.

The Uni-kit can include an external thermal insulating support to be used with the external fire box. As shown in FIG. 9, the support comprises an outer plate 106 that can be made of rigid material, preferably plastic for a lightweight support, and a thermal-insulating plate 105 positioned on top and in contact with plate 106. Preferably, the outer plate 106 and the thermal-insulating plate 105 are L-shaped. The thermal-insulating plate is preferably made of aerogel which provides effective thermal insulation. Other suitable materials can be used for thermal-insulating plate 105. The outer plate 106 and the thermal-insulating plate 106 are attached to each other by any suitable attaching means. The plates are sized to receive on the lower surface 107 a fire-box as shown in FIG. 8

For convenience, the thermal insulating support can be removably mounted on the kitchen unit top or, alternatively, it can be seated on the ground or any available higher mount, as the insulating support would provide heat insulation for the fire box.

A fire starting kit is provided with the Uni-kit package, comprising matches, a metal poker and fire starting products, for example a tube of fire paste. For the firebox included in the Uni-kit, the solid fuel is the most suitable for use.

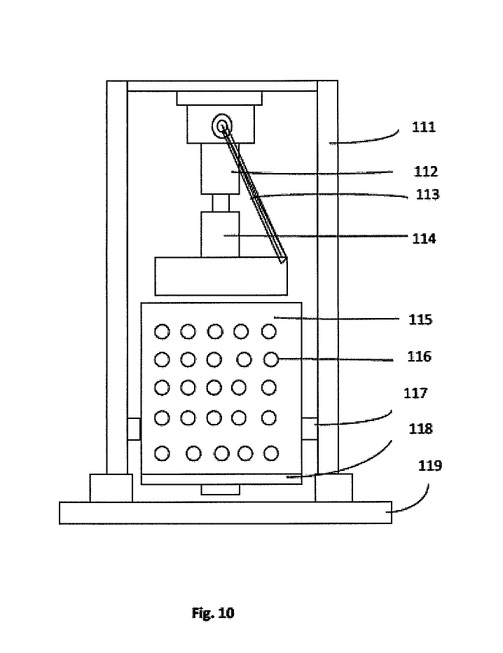

The Uni-kit can be provided with a firebrick molder that is used to make firebricks from wet sawdust and recycled paper. FIG. 10 shows a front view of a molder provided with a tubular chamber 115 pivotally attached through pivotal points 117 to a frame 111. Chamber 115 has an end closed by a shaft end-cap 118 and the opposite end being open for loading the firebrick mix. Holes 116 have been drilled throughout the entire lateral wall of the chamber 115 to allow liquid drainage. The area of the holes is small enough to retain the solid parts of a firebrick mix. Preferably, the area of the holes is about ¼ square inches. A hydraulic jack 112 with ramming shaft 114 is attached to the upper side of the molder frame 111. The hydraulic jack is actuated by a jack arm 113, such as to lower the ram into the chamber 115 and apply pressing force onto the firebrick mix loaded into the chamber 115.

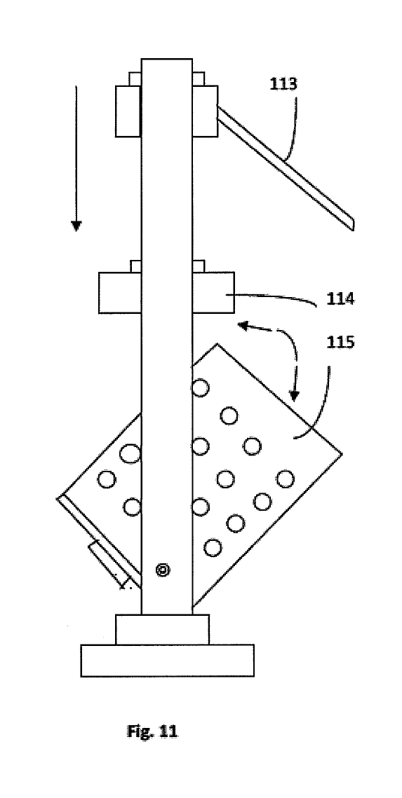

In FIG. 11 there is shown a lateral view of the manual firebrick molder. The ram 114 is actuated by jack arm 113 and can move in a vertical direction. When lowered, it applies a force F in the direction shown in FIG. 11 onto the inside content of the chamber 116. The force F is based on the pressure manually applied from the jack arm. The chamber 115 can rotate around a horizontal axis extending between pivotal points 117.

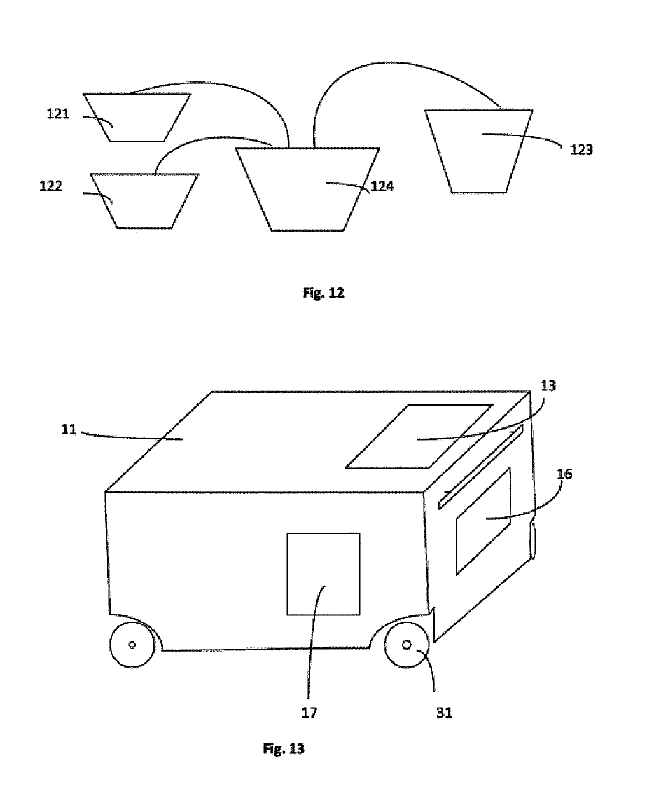

FIG. 12 is a diagram showing the preparation of the mix for firebricks. Wet saw dust 131 and wet paper 132 are mixed and ignition liquid 133 is added to obtain the firebrick mix 134. The ignition liquid component of the mix is intended to increase the ignition qualities of the resulting brick. The mix is then loaded into chamber 115 of the molder and compressed to form into a brick. During the compression, excessive water and liquid is eliminated through holes 116 and the resulting compressed brick can be removed from the chamber 115. The chamber can be rotated as shown in FIG. 12 and the brick is easily removed from the inside of the chamber. The wet firebrick can be dried in a kiln or through any other available method. It should be understood that the firebrick mix may contain any combination of heat releasing products.

The dried brick would substitute wood in the external firebox of the Uni-kit.

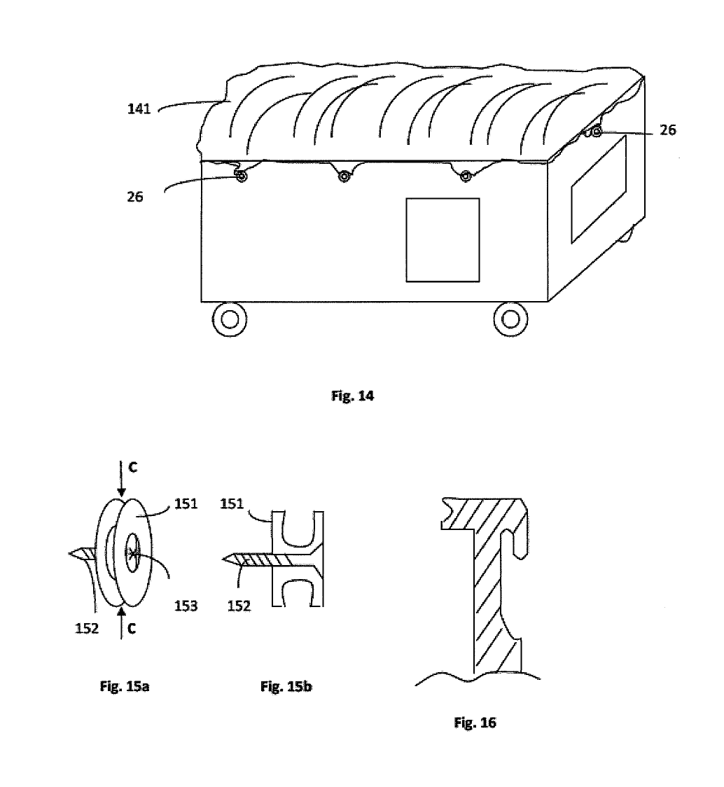

FIG. 13 shows a second example embodiment of the portable kitchen unit where the wheels are recessed slightly so as to allow more economical space usage. The resulting height of the kitchen unit is smaller, making the unit especially suitable for permanent indoor units in small rural structures.

Hooking means collectively designated 26 can be provided on the outer surface of the side walls of the kitchen unit, preferably in the position illustrated, for the cargo of the personal belongings to be hooked on top of the unit. The cargo can be secured to the kitchen unit with ropes or straps, or a canvass by tying them to the hooks, as shown in FIG. 14, such as to cover and strap the cargo of personal belongings during transportation, storage or when the kitchen is not in use. The hooking means take the form of hooks, claws or any other suitable curved fasteners and are preferably uniformly spaced around the periphery of the kitchen unit, proximate the upper side of the kitchen unit. The number and position of the hooks is for illustration purposes only. The position and the number of the hooks are not limited to the configuration shown in the drawings, but other hook configurations can be constructed as well.

FIG. 15a shows a round-shaped hook 151 that can be removably attached to the side walls by means of conventional tapered shaft screw 152 with a flat, countersunk head 153. The hook is provided with a central through-hole for receiving the screw shaft. countersunk head. Preferably, the screw countersunk head 153 is recessed within the outer surface of the hook when installed as to ensure a smooth outer surface of the hook, as clearly seen in FIG. 15b which shows a cross-section view of the hook 151 and screw 152 of FIG. 15a, taken along line C-C.

Alternatively, the hooks can be integrally molded within the outer walls of the kitchen unit. FIG. 16 shows a cross-section view of a molded hook.

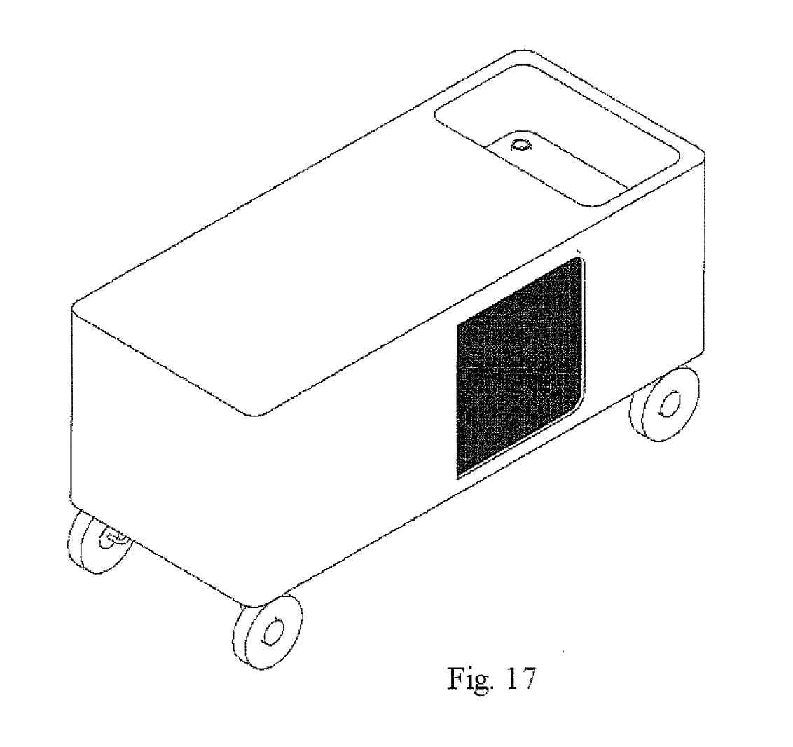

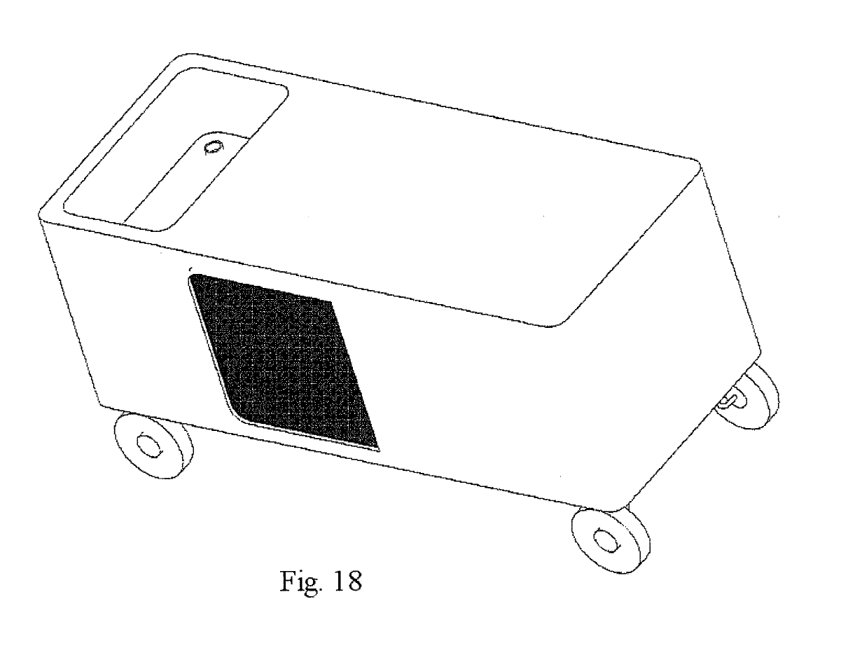

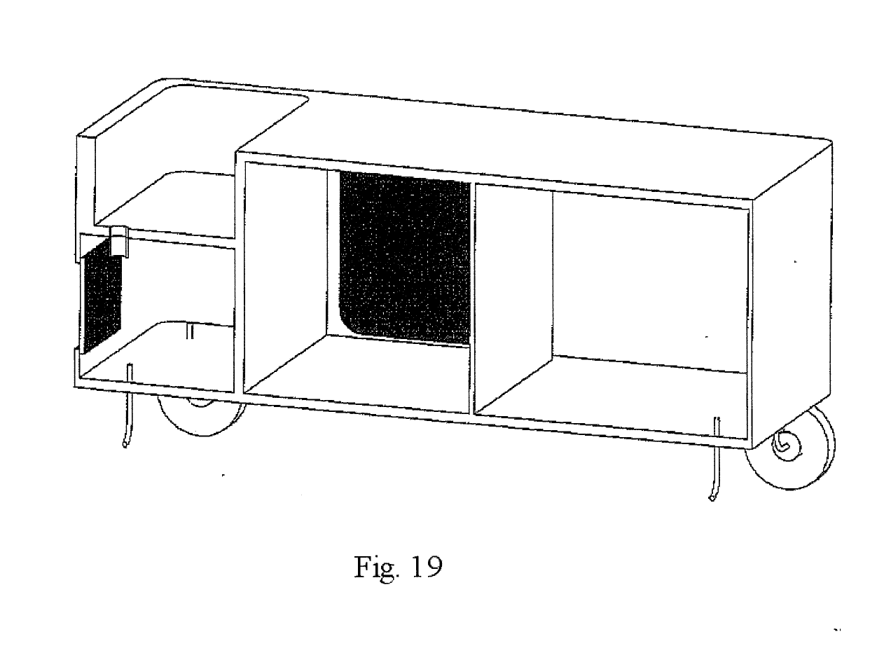

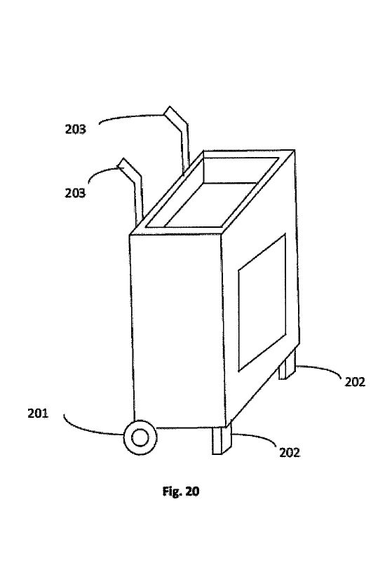

In FIG. 17 and FIG. 18 are shown isometric views of the portable kitchen unit. FIG. 19 shows a tridimensional sectional view of the portable kitchen unit, taken along section A-A of FIG. 1.

In FIG. 20 is shown another embodiment of the portable kitchen unit provided with a pair of wheels 201 and two legs 202. The unit can be reclined with the use of the two handles 203 and easily moved to a stationary place where it can rest on the two wheels 201 and the two legs 202.

The Uni-kit can also be provided with a water filtration system made by a third-party manufacturer. One such example would be a bucket with a clay filter.

The Uni-kit package may include bottles to store the clean water after it is filtered in the filtration system. The Uni-kit may also include basic cooking supplies such as utensils, pots, bowl set, knife, cleaning items, nonperishable food products such as rice, beans, etc. Uni-kit can include a survival kit comprising first-aid kit, survival blanket, hand sanitizer, soap and candles. It can include a tarp and rope to provide means for creating a canopy above the Uni-kit.

The portable kitchen unit is provided with large storing space where the additional elements of the Uni-kit can be stored during transportation and while in use.

The intent of the Uni-kit is to be a package to be deployed and used with aid relief to offer access to safe water, cooking and serving food. The Uni-kit provides the basics for human survival and helps aid relief effort in disaster zones, either because of natural causes, because of war or social or political strife. The Uni-kit has a long shelf life, it can be stored for instant and easy delivery in time of need. The Uni-kit offers practical support to families in need until they are permanently settled. Having access to basic needs as meal preparation proves to also be a great emotional support for people in need.

The Uni-kit is a perfect staple to the world of humanitarian aid. It can be deployed to the relief area instantly. It can then be used in temporary housing until more permanent structures are built. It can also be used as a permanent fixture in smaller shelters for rural areas.

The Uni-kit offers a family a sense of being together during a time of hardship. Daily life will continue around the Uni-kit and communication will help restore morale.

Uni-kit offers not only a portable, durable kitchen unit with sink, storage and a large workspace, but also a portable firebox, a water filtration system, a complete aid package and a survival kit. One example of aid components may include:

Survival kit comprising basic survival kit, survival blanket, candles, alcohol free hand sanitizer, mirror;

Fire starting kit comprising fire box, matches, fire paste, fire poker, supply of fuel;

Basic kitchen supplies comprising pot with lid and ladle, oven mitts, four utensil set, four bowls, a large cutting board with knife, utility cloths and dish towel, drain plug, drainage hose of unspecified length;

Cleaning supplies comprising dish scrubber, disinfectant spray, dish soap, rags, biodegradable garbage bags;

Water supplies comprising drinking cups, water bucket with clay filter;

Food supplies comprising bag of rice, bag of burgol, salt, pepper, various spices, soup stock, garlic powder, drink mix, seeds to start a garden;

Miscellaneous items such as rope, tarp, cloth bags.

Additionally, the Uni-kit may also be alternatively, or double as a portable data centre, and/or a server, and/or a wireless telecom storage unit for use at a relief camp or the like. The telecom equipment may be powered by solar power and/or an internal battery.

It should be understood that the aid components can be selected according to the needs of the people to whom the Uni-kit is deployed.

While the invention has been illustrated and described in detail in the drawings and foregoing description, it is to be understood that it should not be considered restrictive in character and that only the preferred embodiments have been shown and described and thus, various modifications to the disclosure embodiments will be readily apparent to those skilled in the art or science, and the general principles defined herein may be applied to other embodiments and applications without departing from the spirit and scope of the invention. Thus, the present invention is not intended to be limited to the embodiments disclosed, but is to be accorded the widest scope consistent with the principles and features disclosed herein.

1. A portable kitchen unit comprising:
a substantially horizontal planar working area disposed on an upper area of said unit, structured and dimensioned to satisfy the operational criteria of said unit;
a sink assembly structured and adapted for utilitarian co-operation with said planar working area; and
at least one storage compartment positioned beneath said planar working area.

2. The portable kitchen unit according to claim 1 further including means associated with said kitchen to readily facilitate the movement thereof from one location to another.

3. The portable kitchen unit according to claim 2 wherein:
the means are detachable form the structure of said unit.

4. The portable kitchen unit according to claim 1 wherein:
the sink assembly is provided with a drain connected to a drainage hose to facilitate drainage of the sink assembly.

5. The portable kitchen unit according to claim 1 wherein:
each of the at least one storage compartments has a securable hatch.

6. The portable kitchen unit according to claim 5 wherein:
the hatch is a sliding door.

7. The portable kitchen unit according to claim 5 wherein:
the hatch is a hinged door.

8. The portable kitchen unit according to claim 1 wherein:
the at least one storage compartment includes a utility storage compartment located in an area under the sink assembly, and a food storage compartment and a supply storage compartment located in an area under the under the substantially horizontal planar working area adjacent to the utility storage compartment.

9. The portable kitchen unit according to claim 8 wherein:
the utility compartment is sealed off from the adjacent food storage compartment and supply storage compartment.

10. The portable kitchen unit according to claim 1 wherein:
the horizontal planar working area has an upwardly protruding edge.

11. The portable kitchen unit according to claim 1 further comprising:
at least one push-bar or towel rack located on at least one side of the portable kitchen unit.

12. An external cooking firebox comprising:
an enclosed box defining a top side, a bottom side and four lateral sides made of a fire-resistant material having an opening adjacent the top side leaving a lip adjacent the bottom side on one of the lateral sides and the top side having a plurality of holes incorporated therein.

13. The external cooking firebox according to claim 12 wherein:
the fire-resistant material is stainless steel.

14. The external cooking firebox according to claim 12 further comprising:
an external thermal insulating support which comprises:
a rigid lightweight outer layer; and
a thermal insulating inner layer;
the external thermal insulating firebox support being elongated and substantially L-shaped and dimensioned to receive the external cooking firebox.

15. A portable kitchen kit for disaster relief comprising:
a portable kitchen unit as defined in claim 1.

16. The portable kitchen kit for disaster relief according to claim 15 further comprising:
a basic utensil set, at least a pot and ladle, and cleaning supplies.

17. The portable kitchen kit for disaster relief according to claim 15 further comprising:
at least on empty bottle and non-perishable food items.

18. The portable kitchen kit for disaster relief according to claim 15 further comprising:
a first aid and survival kit.

19. The portable kitchen kit for disaster relief according to claim 15 further comprising:
a portable data centre, a server, and/or wireless telecommunication equipment, wherein the equipment is powered by a battery and/or solar power.

20. A portable kitchen kit for disaster relief comprising:
an external cooking firebox as defined in claim 12.
